(19) United States
(12) Patent Application Publication
(10) Pub. No.: US 2026/0053118 A1
(43) Pub. Date: Feb. 26, 2026

(54) CONTAINER FOR BEES

(71) Applicant: Anastasios GERASIMOPOULOS, Toronto (CA)

(72) Inventor: Anastasios GERASIMOPOULOS, Toronto (CA)

(21) Appl. No.: 19/306,744

(22) Filed: Aug. 21, 2025

(30) Foreign Application Priority Data
Aug. 22, 2024 (CA) 3253212

(51) Int. Cl. A01K 49/00; B65D 5/02; B65D 5/42; B65D 5/50; B65D 85/50

(52) U.S. Cl. CPC A01K 49/00; B65D 5/029; B65D 5/4295; B65D 5/5038; B65D 85/50

(57) ABSTRACT

There is provided a container for the shipment of bees, the container preferably being in the shape of a hexagonal prism and having three main sections, an insert, an outer sleeve, and two lids. Each section is preferably constructed of a flat die-cut cardboard that is folded to its final shape. The insert section includes a tray on each side, with each tray configurable to securely hold queen bee cages of differing shapes.

### FIELD OF THE DISCLOSURE

The present disclosure relates to a container for transporting live insects, namely honey bees.

### BACKGROUND

The background description includes information that may be useful in understanding the present inventive subject matter. It is not an admission that any of the information provided herein is prior art or applicant admitted prior art, or relevant to the presently claimed inventive subject matter, or that any publication specifically or implicitly referenced is prior art or applicant admitted prior art.

Queen bees have been shipped for decades by mail or courier to beekeepers for hive establishment or requeening. Current boxes are mostly cardboard or wood, with fixed ventilation points and require manual securing with adhesives or staples. They are primarily used in commercial queen bee production but could also be adapted for other small live insects requiring short-term, ventilated shipping.

Commercial queen bee breeders frequently ship queen bees overnight to customers. However, existing shipping boxes have many key problems.

Assembly can be slow, confusing, and often requires tape, glue, and guesswork. This adds time and labor cost. As well, existing designs can have weak structural integrity during shipping.

Ventilation in many existing designs is inadequate, contributing to a 20-30% mortality rate during transport. Poor circulation that allows hot spots to form inside the box. The assembly difficulties mentioned above can also contribute to poor airflow, when cages are secured incorrectly with tape.

Some designs require additional plastic trays such as JZBZ™ queen cage holders, adding cost and waste. Courier mishandling is common due to unclear warning markings or labels.

Existing box designs have tried to address ventilation by adding mesh windows or vents, but these are often in limited locations, leading to uneven airflow. Assembly improvements have been minimal—most still require adhesive or staples.

There remains a need for a bee shipping container which includes full-perimeter 360° screened ventilation, where the container's assembly is tool-free and intuitive, and which eliminates the need for separate plastic cage trays.

In some embodiments, the numbers expressing quantities of ingredients, properties such as concentration, reaction conditions, and so forth, used to describe and claim certain embodiments of the inventive subject matter are to be understood as being modified in some instances by the term “about.” Accordingly, in some embodiments, the numerical parameters set forth in the written description and attached claims are approximations that can vary depending upon the desired properties sought to be obtained by a particular embodiment. In some embodiments, the numerical parameters should be construed in light of the number of reported significant digits and by applying ordinary rounding techniques. Notwithstanding that the numerical ranges and parameters setting forth the broad scope of some embodiments of the inventive subject matter are approximations, the numerical values set forth in the specific examples are reported as precisely as practicable. The numerical values presented in some embodiments of the inventive subject matter may contain certain errors necessarily resulting from the standard deviation found in their respective testing measurements.

Unless the context dictates the contrary, all ranges set forth herein should be interpreted as being inclusive of their endpoints and open-ended ranges should be interpreted to include only commercially practical values. Similarly, all lists of values should be considered as inclusive of intermediate values unless the context indicates the contrary.

As used in the description herein and throughout the claims that follow, the meaning of “a,” “an,” and “the” includes plural reference unless the context clearly dictates otherwise. Also, as used in the description herein, the meaning of “in” includes “in” and “on” unless the context clearly dictates otherwise.

The recitation of ranges of values herein is merely intended to serve as a shorthand method of referring individually to each separate value falling within the range. Unless otherwise indicated herein, each individual value is incorporated into the specification as if it were individually recited herein. All methods described herein can be performed in any suitable order unless otherwise indicated herein or otherwise clearly contradicted by context. The use of any and all examples, or exemplary language (e.g., “such as”) provided with respect to certain embodiments herein is intended merely to better illuminate the inventive subject matter and does not pose a limitation on the scope of the inventive subject matter otherwise claimed. No language in the specification should be construed as indicating any non-claimed element essential to the practice of the inventive subject matter.

Groupings of alternative elements or embodiments of the inventive subject matter disclosed herein are not to be construed as limitations. Each group member can be referred to and claimed individually or in any combination with other members of the group or other elements found herein. One or more members of a group can be included in, or deleted from, a group for reasons of convenience and/or patentability. When any such inclusion or deletion occurs, the specification is herein deemed to contain the group as modified thus fulfilling the written description of all Markush groups used in the appended claims.

### SUMMARY

The present invention aims to solve the above-mentioned problems by removing the need for glue or tape with a self-locking, intuitive fold-and-tab system; by increasing airflow with 360° screened openings for temperature regulation; by including a rubber band system to secure cages without blocking airflow; and by eliminating the need for separate plastic cage trays.

The present disclosure is directed to a container for shipment of bee cages, comprising: a plurality of sides, each side having a length; an insert section, comprising: a holding tray on each of the plurality of sides, the holding tray having two tray walls extending longitudinally, wherein the tray walls are movable from a first position to a second position; and securing means on each of the plurality of the sides for holding the bee cages in the holding trays; an outer sleeve, comprising: a plurality of ventilation ports; and attachment means for securing the outer sleeve to the insert section; and two lid portions being removably securable to at least one of the insert section and the outer sleeve.

In a preferred embodiment, the plurality of sides includes six sides, wherein the container has a hexagonal prism shape.

In another embodiment, the tray walls are dimensioned to hold a first type of bee cage when in the first position, and are dimensioned to hold a second type of bee cage when in the second position.

In one embodiment, each of the tray walls includes a first wall section and a second wall section, with each section extending longitudinally.

In a preferred embodiment, for each holding tray: when in the first position, the tray walls are approximately perpendicular to the side of the container; and when in the second position, each of the first wall sections are approximately perpendicular to the side of the container, and each of the second wall sections are approximately parallel to the side of the container.

In one embodiment, the insert section, the outer sleeve and the two lid portions are each made of a single sheet die-cut material.

In a preferred embodiment, the die-cut material is cardboard.

In one embodiment, each of the plurality of ventilation ports includes a mesh screen.

In a preferred embodiment, the plurality of ventilation ports are spaced around the plurality of sides of the container.

In another embodiment, the securing means includes at least one notch on each of the plurality of sides for receiving securement bands.

In a preferred embodiment, the at least one notch includes two notches, and the securement bands are elastic bands.

In one embodiment, the attachment means comprises an outer tab, for insertion into the insert section.

In another embodiment, each of the lid portions further includes at least one lid flap extension on each of the plurality of sides, for friction fit insertion into at least one of the insert section and the outer sleeve.

In another preferred embodiment, the present disclosure is directed to a kit for assembling a container for shipment of bee cages, the kit comprising: a die-cut sheet for an insert; a die-cut sheet for an outer sleeve; and two die-cut sheets for lid portions.

In a preferred embodiment, a kit for assembling a container for shipment of bee cages comprises: a) a die-cut sheet for an insert, the insert comprising: a plurality of side sections, each having a length and a width, and each side section comprising: a sidewall section including two tray walls extending longitudinally, the tray walls having die-cut perforations at each end and on an outer side, and tray fold lines on an inner side; an end section at each end of the sidewall section, and including two end slots and at least one notch for receiving an elastic band; a first fold line extending the width of the side section and connecting the sidewall section with each end section, the first fold line being for folding the end section in half; a second fold line across a width of each of the end sections; and the tray walls further including a longitudinal fold line and end tabs at each end, wherein when the second fold line is folded, each of the tray wall end tabs are inserted into one of the end slots; wall fold lines between each side section and extending the length of the side section; an end tab for securing into an interior of the insert when assembled; b) a die-cut sheet for an outer sleeve, comprising: a plurality of sleeve wall sections; a fold line for folding the outer sleeve in half; fold lines between each of the sleeve wall sections; a plurality of ventilation ports; a first end tab for connection to the insert; and a second end tab and a corresponding slot for receiving the second end tab when the outer sleeve is folded around the insert; c) two die cut sheets for lid portions, each lid portion having a center section and a plurality of lid flaps extending outwardly; wherein each of the lid flaps includes a first fold line for folding the lid flap in half, and a second fold line for folding the lid flap to be generally perpendicular to the center section; wherein the number of the plurality of side sections, the plurality of sleeve wall sections, and the plurality of lid flaps are all equal.

In a preferred embodiment, the plurality of lid flaps include a plurality of tongue portions.

In another embodiment, a mesh screen is to be positioned inside the two layers of the outer sleeve when folded in half.

In one embodiment, an enviro capsule is to be placed inside the assembled container.

In another embodiment, each of the sleeve wall sections includes a plurality of the ventilation ports.

Various objects, features, aspects and advantages of the inventive subject matter will become more apparent from the following detailed description of preferred embodiments, along with the accompanying drawing figures in which like numerals represent like components.

### BRIEF DESCRIPTION OF THE DRAWINGS

The present disclosure will be better understood having regard to the drawings in which:

FIG. 1 shows a side perspective view of one embodiment of the invention, with the container on its side,

FIG. 2 shows a side perspective view of one embodiment of the invention, with the container standing on end,

FIG. 3 shows a top view of one embodiment of the outer sleeve of the invention,

FIG. 4 shows a top view of one embodiment of the insert of the invention,

FIG. 5 shows a top view of one embodiment of two lid portions of the invention,

FIG. 6 shows a top perspective view of one embodiment of the assembled insert and outer sleeve, with wooden queen cages therein,

FIG. 7 shows a perspective view of one embodiment of the assembled insert and outer sleeve on its side,

FIG. 8 shows a top view of one embodiment of the insert in an open position, with JZBZ™ queen cages therein,

FIG. 9 shows a side perspective view of the embodiment of FIG. 8,

FIG. 10 shows a top view of one embodiment of the assembled insert, with JZBZ™ queen cages therein,

FIG. 11 shows a perspective view of the embodiment of FIG. 10.

### DETAILED DESCRIPTION OF THE DRAWINGS

As can be seen in the Figures, an embodiment of the present invention includes a container 10, the container preferably including three main parts, an insert 12, an outer sleeve 14 and two lid portions 16.

In one preferred embodiment, the container 10 is a hexagonal prism (hexagon top and bottom) shape. While a hexagonal shape is shown in the Figures, the container 10 could be of a variety of shapes, such as square, rectangular, octagonal, etc.

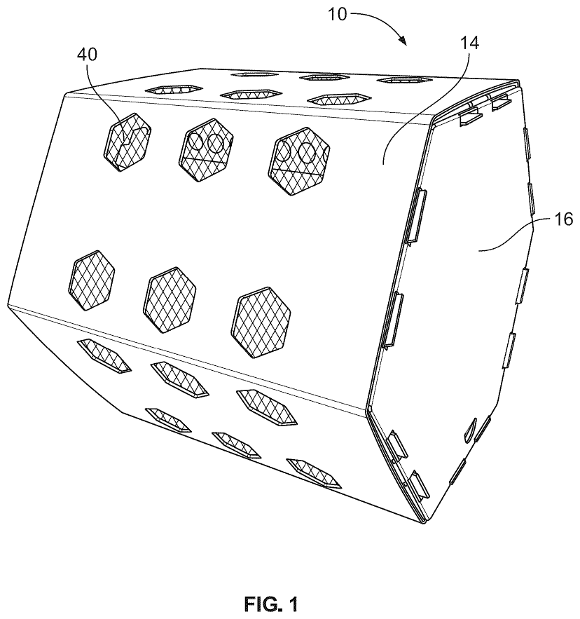

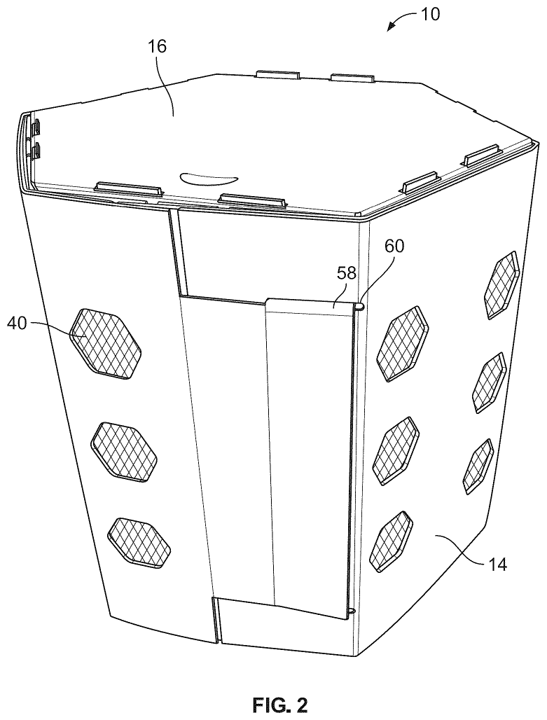

In one embodiment, the container 10 is made of a rigid cardboard material. The container 10 can be available in a variety of sizes. Preferably, it is available in 4 different sizes (mini, small, medium and large), with all sizes having the same diameter hexagon lids (preferably 25 cm) and varying in length that allows the container to accommodate more or less bees. The assembled container can be seen in FIGS. 1 and 2.

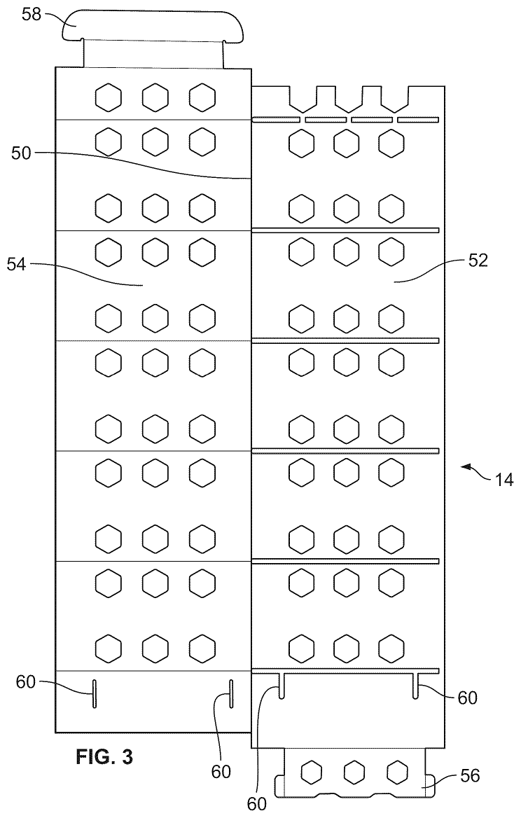

In one embodiment, each of the insert 12, outer sleeve 14, and lid portions 16 starts off as a flat die-cut (of preferably cardboard) cut out that needs to be assembled to take its final shape. These can be seen in FIGS. 3-5.

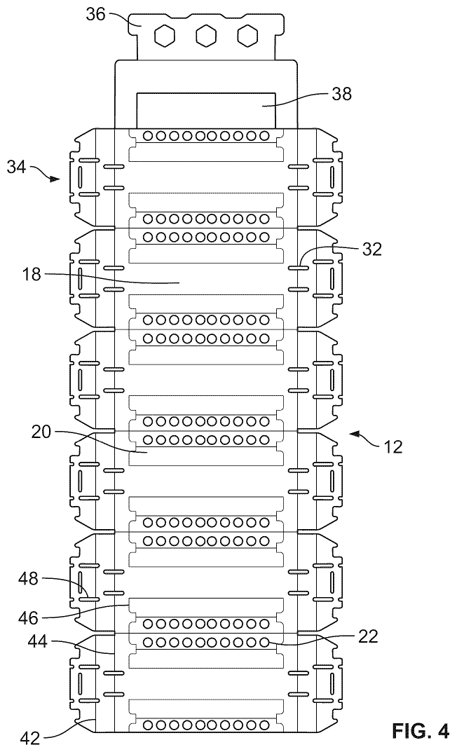

The insert 12, when assembled, is designed to be the area that houses the bees during transport. An unassembled view of one embodiment of the insert 12 can be seen in FIG. 4. When assembled, the outer sleeve 14 surrounds the insert.

In one embodiment, the outer sleeve 14, when assembled, is folded in half along a sleeve crease 50 to make it two-ply. In a preferred embodiment, a screen mesh 40 is placed within the outer sleeve 14 (as seen in FIGS. 1, 2 and 6). The screen mesh 40 serves to prevent any bees that might escape from leaving the protection of the container 10.

In some embodiments, when assembled, the final shape of the insert 12 is a hexagonal prism. In one embodiment, the insert 12 then includes six holding trays 18, one holding tray 18 for each side of the hexagon that are designed to carry queen cages, which contain the bees. Each holding tray 18 includes a tray wall 20 on each side, along with a tray end 34 at each end.

In one embodiment, as can be best seen in FIG. 4, each tray wall includes a row of die-cut holes 22 that span the length of each tray wall 20.

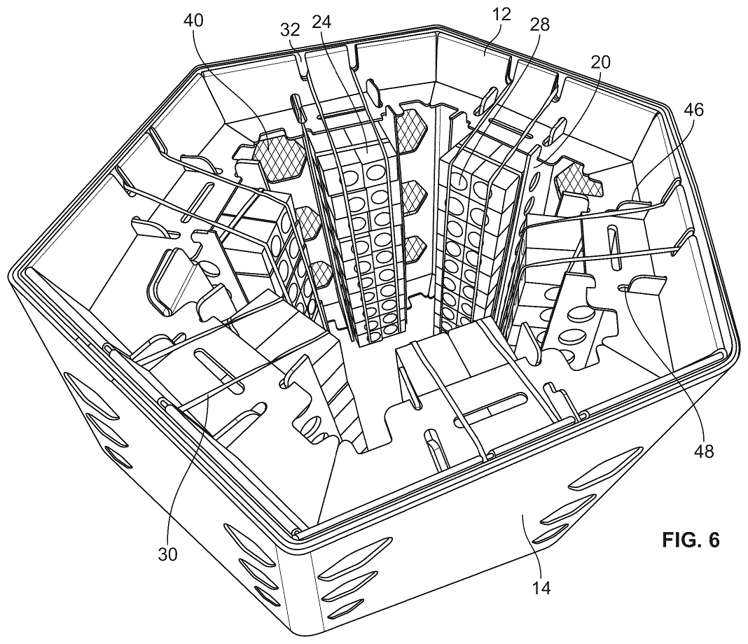

The two most popular style queen cages known in the art are a wooden queen cage 24 that is a small rectangular piece of wood with a queen cage hole 28 drilled into it that hold the bee and provide ventilation. This can be best seen in FIG. 6.

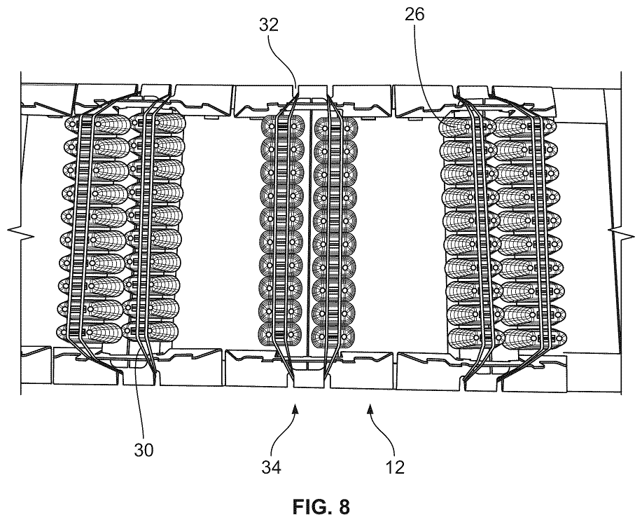

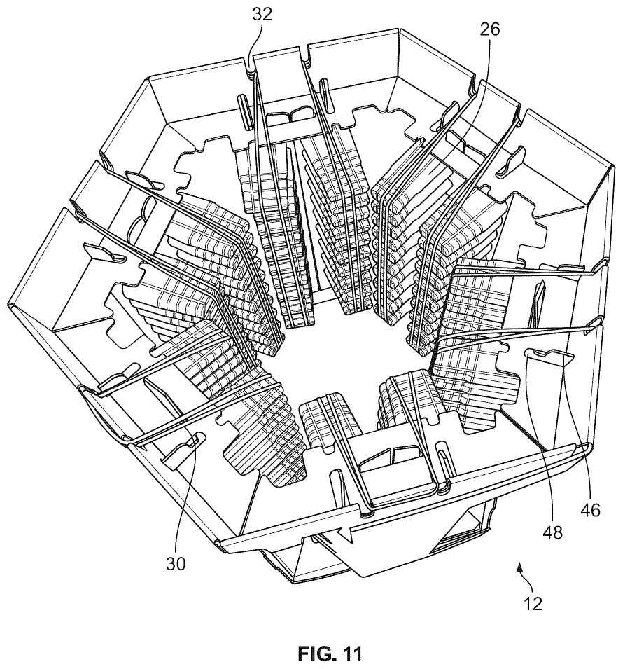

The second style of queen cages that this container 10 is designed to carry are JZBZ™ queen cages 26. This can be seen in FIGS. 8-11.

It is a unique feature of the present invention that each cardboard holding tray is designed to fit both style queen cages 24, 26.

As can be seen in the embodiment shown in FIG. 6, when folded and assembled with the tray walls 20 standing up vertically this configuration is meant to carry the wooden style queen cages 24.

As is known in the art, the JZBZ queen cages 26 include a thin tube portion at one end (not shown). In a preferred embodiment, the die-cut holes 22 are dimensioned to allow the thin tube portion of the JZBZ queen cages 26 to be inserted. Thus, in the preferred embodiment used to transport the JZBZ queen cages 26, the tray walls 20 are bent at a 90-degree angle. This allows the die-cut holes 22 to be positioned to secure the JZBZ queen cages 26. This can be seen in FIGS. 8-11.

As would be appreciated, the holding tray 10 and tray walls 20 allow for dual-purpose functionality that holds both the wooden queen cage 24 and the JZBZ queen cage 26.

It is worth noting that the JZBZ queen cages 26 are usually held using a specially designed plastic tray that is sold separately at an additional cost. With the present container 10, it eliminates the need for an additional plastic tray. Additionally, since some embodiments are preferably made of cardboard (in some embodiments), the present container 10 is a more environmentally friendly option.

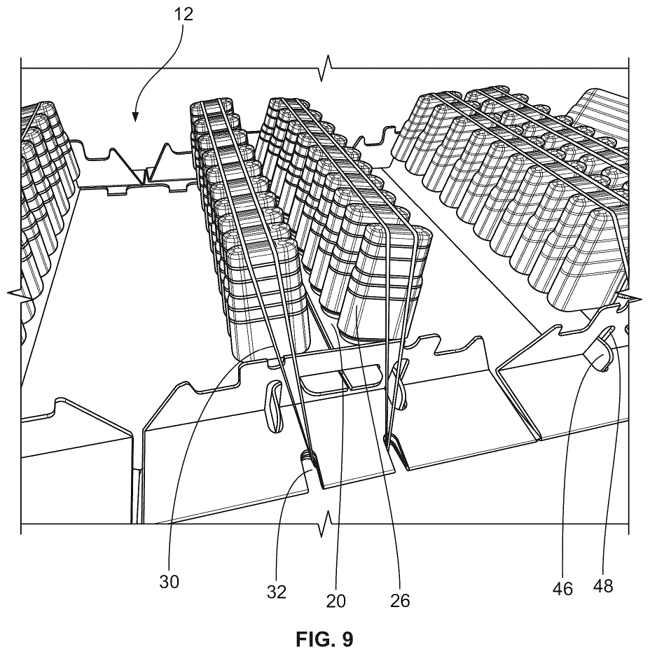

The insert 12 section lays flat initially until the holding trays 18 are loaded with the queen cages 24, 26 to be shipped. This can be seen in FIGS. 8-9.

In one preferred embodiment, once the bees are in the holding trays 18, a rubber band 30 is positioned to hold the queen cages 24, 26 in place for each holding tray 18 to prevent them from falling out. In one embodiment of the invention, notches 32 are specifically placed to allow for rubber bands 30 to be used and placed properly.

### Assembly

In a preferred embodiment, when the insert 12 is ready to be assembled (as seen in FIG. 4), the insert 12 is placed on its side and each tray end 34 is secured in place in a folded, locking arrangement. First fold lines 42 are folded to overlap, and second fold lines 44 are folded back at a roughly 90-degree angle. Each tray wall 20 is then folded roughly 90-degrees, thus allowing a tray tab 46 at the end of each tray wall 20 to mate with a tray slot 48 which is located at the tray end 34.

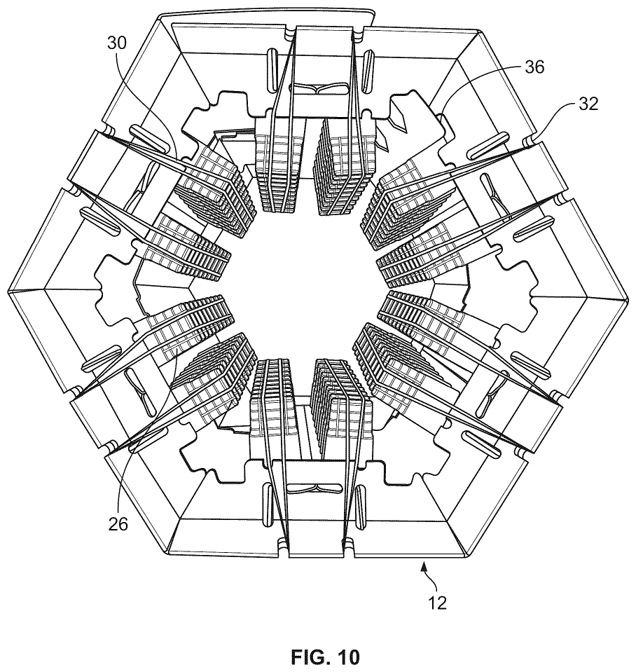

To secure the insert 12 in an assembled arrangement, the holding trays 18 are folded around each other to form the finished shape, which in this embodiment is a hexagon. Once in the desired shape, the insert end tab 36 is tucked inside, and engages with, the interior of the insert 12, as can be seen in FIG. 10. The folded, assembled insert 12 can be seen in FIGS. 8-11.

The outer sleeve 14 (FIG. 3) is used to wrap around the insert 12 to add strength and structure to the container 10. In a preferred embodiment, the outer sleeve 14 is die-cut then folded in half along a sleeve crease 50 to make it two-ply, having an inner side 52 and outer side 54. The screen mesh 40 is then placed in between the layers of the folded outer screen 14, to prevent any bees that might escape the queen cages 24, 26 from leaving the protection of the container 10.

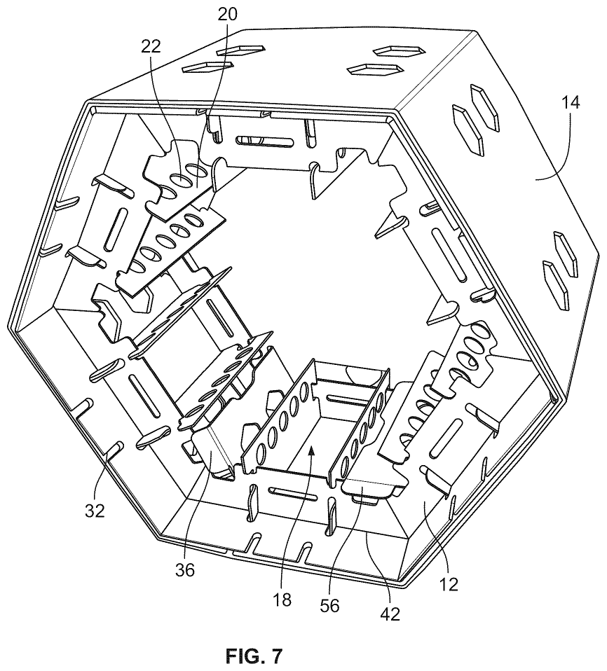

In a preferred embodiment, after being folded in half, the outer sleeve 14 is wrapped around the exterior of the insert 12, with inner tabs 56 being tucked through insert end slot 38, to engage with the interior of insert 12. This can be best seen in FIG. 7. This arrangement helps keep the insert 12 in place, preventing it from sliding out of the outer sleeve 14.

To further secure the outer sleeve 14 in place, outer tabs 58 are tucked into sleeve slots 60. This can be seen in FIG. 2.

In some embodiments, each of the lid portions 16 are both die-cut cardboard cutouts similar to the insert 12 and outer sleeve 14. In a preferred embodiment, each lid portion 16 includes six lid flaps 62, with each flap corresponding to a side of the hexagonal container 10. If the container 10 is of a differing shape, there would be a differing number of lid flaps 62.

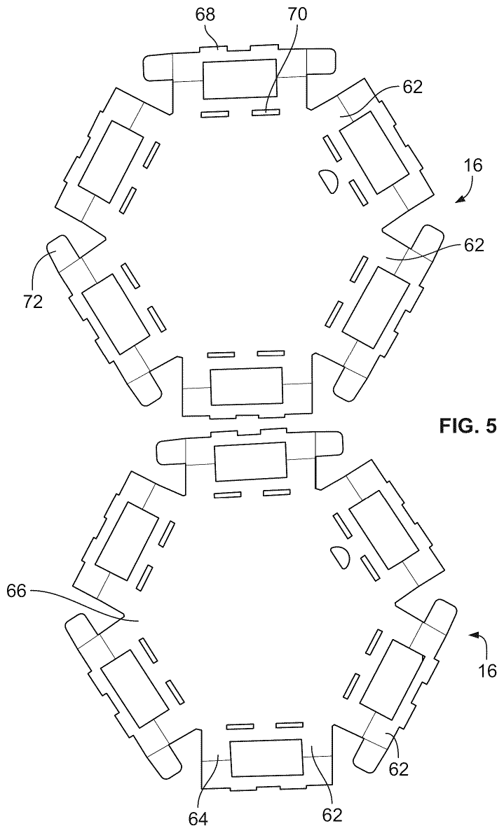

In a preferred embodiment seen in FIG. 5, each lid flap 62 includes a first fold line 64, a second fold line 66, two lid tabs 68, and two lid slots 70. In one embodiment, as shown in FIG. 5, each alternating lid flap 62 includes two tongue portions 72. In another embodiment, each lid flap 62 could include a single tongue portion 72.

To assemble lid portions 16, each lid flap 62 is folded inwards in half along the first fold line 64, as well as being folded approximately 90 degrees inwards along second fold line 66. These two folding actions allow tongue portion 72 to engage inside the first fold of the neighboring lid flap 62, and connects each lid tab 68 with lid slot 70, and locking each lid flap 62 in place, extending roughly 90 degrees inwards from the lid portion 16.

In this preferred embodiment, once the two lid portions 16 are assembled, they can then be placed inside the top and bottom holes of the assembled combination of the insert 12 and exterior sleeve 14, to close the container 10 and complete the assembly. Once everything is assembled and the lids are in place, container 10 is now very structurally sound.

Finally, in some embodiments, to secure everything in place are lid sized sticker security seals (not shown). These seals are made available to lock in both lids top and bottom and take the guesswork out of where to place the tape to ensure a proper assembly.

It should be understood that the above description of the method of assembly is for one preferred embodiment. Various changes to the fold lines, tabs, and slots could occur, that would result in the same container structure.

### Key Features

1) The hexagonal prism shape of the container 10. While different shapes may be used within the scope of the invention, a hexagonal shape is unique compared to other bee shipping containers on the market. This shape is beneficial compared to other containers because when stacked during shipping the hexagonal shape allows the container to stay ventilated, as the hexagonal shape prevents the ventilation holes from being blocked during transport.
2) The dual-purpose trays. The six trays are designed to carry both style queen cages 24, 26 without any additional accessories like the plastic tray designed to carry the JZBZ queen cages 26, for example. Additionally, this container 10 can be positioned at any angle so there is no wrong side up.
3) The assembly does not require any glue or staples like other containers. Every part of the container 10 is designed to friction fit in place. This makes it more convenient for the end user when putting the container 10 together.
4) The locking mechanism on the insert 12 and outer sleeve 14 are unique to this invention. The ease of use and secure hold is beneficial feature of this container 10.
5) The built in notches for the rubber bands, which makes securing the queen cages easy and efficient.
6) The holes in the trays that act to provide ventilation to the wooden queen cages 24 and are a secure fit for the JZBZ queen cage 26.
7) The two-ply outer sleeve 14 provides ventilation and dramatically increases the strength of the container 10, also the screen mesh 40 prevents bees from escaping the container 10 if they manage to break out of the queen cages.
8) Once assembled, there is an option to add an enviro capsule (not shown). This optional element can be added to the center space of the container 10 after the holding trays 18 are filled. The purpose of this device is to help maintain safe temperatures and favorable conditions for the bees while they are in transport. The sensor in the device can detect when temperatures get too high and a fan will turn on to vent the container 10. If temperatures drop, a heat-plate will activate and heat the container 10 gradually and safely. Additional sensors may be in place for O₂ detection, etc.

The embodiments described herein are examples of structures, systems or methods having elements corresponding to elements of the techniques of this application. This written description may enable those skilled in the art to make and use embodiments having alternative elements that likewise correspond to the elements of the techniques of this application. The intended scope of the techniques of this application thus includes other structures, systems or methods that do not differ from the techniques of this application as described herein, and further includes other structures, systems or methods with insubstantial differences from the techniques of this application as described herein.

Moreover, the previous detailed description is provided to enable any person skilled in the art to make or use the present invention. Various modifications to those embodiments will be readily apparent to those skilled in the art, and the generic principles defined herein may be applied to other embodiments without departing from the spirit or scope of the invention described herein. Thus, the present invention is not intended to be limited to the embodiments shown herein, but is to be accorded the full scope consistent with the claims, wherein reference to an element in the singular, such as by use of the article “a” or “an” is not intended to mean “one and only one” unless specifically so stated, but rather “one or more”. All structural and functional equivalents to the elements of the various embodiments described throughout the disclosure that are known or later come to be known to those of ordinary skill in the art are intended to be encompassed by the elements of the claims. Moreover, nothing disclosed herein is intended to be dedicated to the public regardless of whether such disclosure is explicitly recited in the claims.

The discussion herein provides many example embodiments of the inventive subject matter. Although each embodiment represents a single combination of inventive elements, the inventive subject matter is considered to include all possible combinations of the disclosed elements. Thus, if one embodiment comprises elements A, B, and C, and a second embodiment comprises elements B and D, then the inventive subject matter is also considered to include other remaining combinations of A, B, C, or D, even if not explicitly disclosed.

As used herein, and unless the context dictates otherwise, the term “coupled to” is intended to include both direct coupling (in which two elements that are coupled to each other contact each other) and indirect coupling (in which at least one additional element is located between the two elements). Therefore, the terms “coupled to” and “coupled with” are used synonymously.

It should be apparent to those skilled in the art that many more modifications besides those already described are possible without departing from the inventive concepts herein. The inventive subject matter, therefore, is not to be restricted except in the spirit of the appended claims. Moreover, in interpreting both the specification and the claims, all terms should be interpreted in the broadest possible manner consistent with the context. In particular, the terms “comprises” and “comprising” should be interpreted as referring to elements, components, or steps in a non-exclusive manner, indicating that the referenced elements, components, or steps may be present, or utilized, or combined with other elements, components, or steps that are not expressly referenced. Where the specification or claims refer to at least one of something selected from the group consisting of A, B, C . . . and N, the text should be interpreted as requiring only one element from the group, not A plus N, or B plus N, etc.

1. A container for shipment of bee cages, comprising:
a plurality of sides, each side having a length;
an insert section, comprising:
a holding tray on each of the plurality of sides, the holding tray having two tray walls extending longitudinally, wherein the tray walls are movable from a first position to a second position; and
securing means on each of the plurality of the sides for holding the bee cages in the holding trays;
an outer sleeve, comprising:
a plurality of ventilation ports; and
attachment means for securing the outer sleeve to the insert section; and
two lid portions being removably securable to at least one of the insert section and the outer sleeve.

2. The container of claim 1, wherein the plurality of sides includes six sides, wherein the container has a hexagonal prism shape.

3. The container of claim 1, wherein the tray walls are dimensioned to hold a first type of bee cage when in the first position, and are dimensioned to hold a second type of bee cage when in the second position.

4. The container of claim 3, wherein each of the tray walls includes a first wall section and a second wall section, with each section extending longitudinally.

5. The container of claim 4, wherein for each holding tray:
when in the first position, the tray walls are approximately perpendicular to the side of the container; and
when in the second position, each of the first wall sections are approximately perpendicular to the side of the container, and each of the second wall sections are approximately parallel to the side of the container.

6. The container of claim 1, wherein the insert section, the outer sleeve and the two lid portions are each made of a single sheet die-cut material.

7. The container of claim 6, wherein the die-cut material is cardboard.

8. The container of claim 1, wherein each of the plurality of ventilation ports includes a mesh screen.

9. The container of claim 1, wherein the plurality of ventilation ports are spaced around the plurality of sides of the container.

10. The container of claim 1, wherein the securing means includes at least one notch on each of the plurality of sides for receiving securement bands.

11. The container of claim 9, wherein the at least one notch includes two notches, and the securement bands are elastic bands.

12. The container of claim 1, wherein the attachment means comprises an outer tab, for insertion into the insert section.

13. The container of claim 1, wherein each of the lid portions further includes at least one lid flap extension on each of the plurality of sides, for friction fit insertion into at least one of the insert section and the outer sleeve.

14. A kit for assembling a container for shipment of bee cages, the kit comprising:
a) a die-cut sheet for an insert;
b) a die-cut sheet for an outer sleeve; and
c) two die-cut sheets for lid portions.

15. The kit from claim 14, wherein:
a) the insert comprises:
a plurality of side sections, each having a length and a width, and each side section comprising:
a sidewall section including two tray walls extending longitudinally, the tray walls having die-cut perforations at each end and on an outer side, and tray fold lines on an inner side;
an end section at each end of the sidewall section, and including two end slots and at least one notch for receiving an elastic band;
a first fold line extending the width of the side section and connecting the sidewall section with each end section, the first fold line being for folding the end section in half;
a second fold line across a width of each of the end sections; and
the tray walls further including a longitudinal fold line and end tabs at each end, wherein when the second fold line is folded, each of the tray wall end tabs are inserted into one of the end slots;
wall fold lines between each side section and extending the length of the side section;
an end tab for securing into an interior of the insert when assembled;
b) the outer sleeve comprises:
a plurality of sleeve wall sections;
a fold line for folding the outer sleeve in half;
fold lines between each of the sleeve wall sections;
a plurality of ventilation ports;
a first end tab for connection to the insert; and
a second end tab and a corresponding slot for receiving the second end tab when the outer sleeve is folded around the insert;
c) each of the lid portions includes a center section and a plurality of lid flaps extending outwardly;
wherein each of the lid flaps includes a first fold line for folding the lid flap in half, and a second fold line for folding the lid flap to be generally perpendicular to the center section;
wherein the number of the plurality of side sections, the plurality of sleeve wall sections, and the plurality of lid flaps are all equal.

16. The kit of claim 15, wherein the plurality of lid flaps include a plurality of tongue portions.

17. The kit of claim 15, further comprising a mesh screen to be positioned inside the two layers of the outer sleeve when folded in half.

18. The kit of claim 15, further comprising an enviro capsule to be placed inside the assembled container.

19. The kit of claim 15, wherein each of the sleeve wall sections includes a plurality of the ventilation ports.
